(19) United States
(12) Patent Application Publication
(10) Pub. No.: US 2018/0243838 A1
(43) Pub. Date: Aug. 30, 2018

(54) CLAMPING UNIT FOR A CHUCK OF A MACHINE TOOL SPINDLE

(71) Applicant: Step-Tec AG, Luterbach (CH)

(72) Inventors: Edwin Reinhard, Niederoenz (CH); Dominique Steffen, Langendorf (CH)

(21) Appl. No.: 15/933,434

(22) Filed: Mar. 23, 2018

(30) Foreign Application Priority Data
Feb. 28, 2017 (EP) 17158297.6

(51) Int. Cl. B23B 31/16

(52) U.S. Cl. CPC B23B 31/16045; B23B 2231/42

(57) ABSTRACT

A clamping unit for a chuck of a machine tool spindle contains a threaded shaft for adjusting the clamping jaws of the chuck. The threaded shaft is axially adjustable in the clamping unit by means of a threaded nut connected to a rotor of a servomotor actuator. An electrically actuable, releasable clutch has a first clutch element, which is connected in a rotationally secure and axially displaceable manner to the threaded shaft, and a second clutch element, which cooperates with the first clutch element and is connected in a rotationally secure manner to the rotor. When the clutch is activated, the threaded shaft and the threaded nut are mutually connected in a rotationally secure manner and prevent axial displacement of the threaded shaft.

### CROSS-REFERENCE TO PRIOR APPLICATIONS

Priority is claimed to European Patent Application No. 17 158 297.6, filed on Feb. 28, 2017, the entire disclosure of which is hereby incorporated by reference herein.

### FIELD

The invention relates to a clamping unit for a chuck of a machine tool spindle, containing a threaded shaft for adjusting the clamping jaws of the chuck, which threaded shaft is axially adjustable in the clamping unit by means of a threaded nut connected to a rotor of a servomotor actuator.

### BACKGROUND

Clamping units serve on machine tools to actuate chucks in which a workpiece or a tool is clamped. Clamping units may have a force for tightening and/or loosening be applied by pneumatic or hydraulic drives acting in the longitudinal direction of a spindle. If such drives are not present on the machine tool or are not desired, electric drives may be used to perform the tightening and loosening movements.

Clamping units in which the clamping force is maintained with the aid of springs are known, for instance from document DE102006017645A1. In clamping units of this kind, the loosening force acts counter to the spring force, so that they are unsuitable, for instance, for the actuation of chucks with which a workpiece or tool is intended to be clamped, according to choice, on the outside or the inside.

Under the title “electrically operated clamping mechanism”, document EP2081717A1 describes a clamping unit in which the adjusting movements for tightening and loosening are realized via a threaded spindle drive, wherein this is operatively connected to a sliding bevel gear, which for its part is drivable via an external servomotor. The set clamping force is maintained during operation, that is to say while the spindle is rotating, only through the self-locking of the threaded spindle drive and of the thereto connected sliding bevel gear. This concept does not allow high spindle speeds, for instance in the region of 10,000 rpm, nor high rotational accelerations.

### SUMMARY

In an embodiment, a clamp for a chuck of a machine tool spindle includes a threaded shaft for adjusting clamping jaws of the chuck. The threaded shaft may being axially adjustable in the clamp using a threaded nut connected to a rotor of a servomotor actuator. The clamp may further include an electrically actuable, releasable clutch, having a first clutch element that is connected in a rotationally secure and axially displaceable manner to the threaded shaft, and a second clutch element that cooperates with the first clutch element and is connected in a rotationally secure manner to the rotor.

### BRIEF DESCRIPTION OF THE DRAWINGS

The present invention will be described in even greater detail below based on the exemplary FIGURE. The invention is not limited to the exemplary embodiments. Other features and advantages of various embodiments of the present invention will become apparent by reading the following detailed description with reference to the attached drawing, which illustrate the following:

FIG. 1 illustrates a schematic, cutaway perspective view of a motor spindle having a clamping unit according to an embodiment of the invention

### DETAILED DESCRIPTION

Embodiments of the present invention include a clamping unit which is capable of applying high forces in two opposite axial directions and of maintaining these even at high spindle speeds.

Embodiments according to the invention have the advantage that a clutch ensures that during operation, and in particular during the raising and lowering of the spindle speed, the threaded shaft rotates together with the threaded nut and thus unwanted adjustment of the clamping force is prevented.

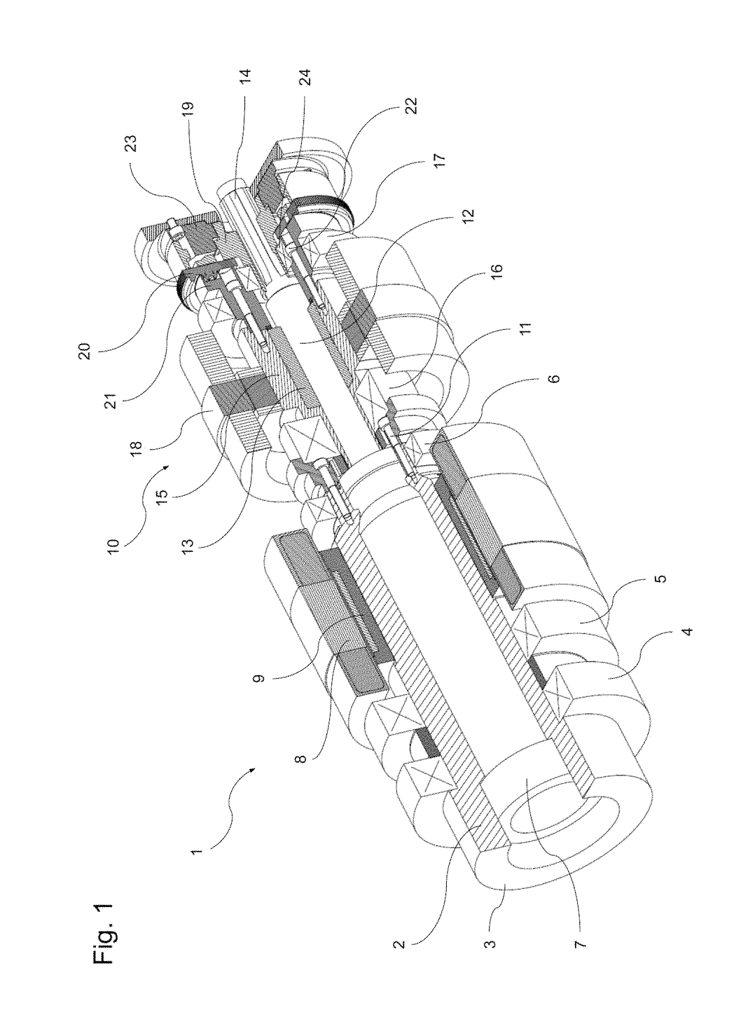

FIG. 1 shows a schematic, cutaway perspective view of a motor spindle having a clamping unit according to an illustrative embodiment of the invention.

The motor spindle 1 has a hollow spindle shaft 2, in which a clamping piston 7 is accommodated such that it is movable axially back and forth. A chuck can be fastened and secured to the end face 3 of the spindle shaft 2. For example, by axial movements of the clamping piston 7, the chuck can be tightened or loosened. This axial movement is performed by the clamping unit 10, which is described below. On the outside of the spindle shaft 2 is arranged a spindle motor rotor 9, which is connected in a rotationally secure manner thereto and which, for its part, is surrounded by a spindle motor stator 8. For the rotatable mounting of the spindle shaft 2, bearings 4, 5 and 6 may be used.

In an embodiment, the clamping unit 10 is connected with screws 11 to the motor spindle 1. On the side of the clamping piston 7 that lies opposite the end face 3, a threaded shaft may be arranged, which in the example is configured as a roller screw shaft 12 and is surrounded by a therewith cooperating roller screw nut 13. The roller screw shaft 12 may be adjoined by a splined shaft 14 or by a shaft region with corresponding function. The roller screw nut 13 is connected to an actuator rotor 15, which is borne by a bearing 16 and, for its part, is surrounded by an actuator stator 18. By rotations of the actuator rotor 15 while the roller screw shaft 12 is stationary, the clamping piston 7 can thus be adjusted in the axial direction and hence open and close the chuck. Depending on whether a workpiece or tool to be clamped is intended to be clamped from the outside or the inside with the chuck, the clamping force exerted by the clamping piston is a tensile force or a compressive force. The magnitude of the clamping force is determined by the torque of the actuator (i.e., actuator rotor 15 and actuator stator 18) and measured, for instance, via its electric current consumption.

In a embodiment, the splined shaft 14 is accommodated in a rotationally secure, yet longitudinally displaceable manner in a clutch rotor 19. A clutch winding 23 may be fastened to a surrounding housing. Opposite the clutch rotor 19 is arranged an armature disc 20 connected to a connecting sleeve 21, and the clutch rotor 19 is supported by a bearing 24 against the connecting sleeve 21 and may be fastened with screws 22 to the actuator rotor 15. On the outside, the connecting sleeve 21 is borne by a bearing 17.

According to an embodiment, for the clamping of a workpiece or tool, the clutch winding 23 is kept currentless while the spindle is stationary so that no force closure exists between the clutch rotor 19 and the armature disc 20. If now the actuator rotor 15 (and with it the roller screw nut 13) is turned, the non-rotating roller screw shaft 12 (and with it the clamping piston 7) is displaced in the axial direction. The clamping force can here be controlled via the current flow in the actuator. For this, the spindle motor rotor 9 can be held with the spindle motor stator 8. After the clamping operation, the clutch winding 23 is firstly energized, whereby the armature disc 20 is pulled against the clutch rotor 19 and is non-positively connected thereto. Upon the subsequent raising of the spindle motor (e.g., spindle motor stator 8 and spindle motor rotor 9), the actuator rotor 15 is transported by means of the clutch (e.g., clutch motor 19, armature disc 20, ad clutch winding 23) and a relative movement between the roller screw shaft 12 and the roller screw nut 13 is reliably prevented. During the rotation of the spindle, the actuator (e.g., actuator rotor 15 and actuator stator 18) should not be actuated and the roller screw drive (e.g., roller screw shaft 12 and roller screw nut 13) should have force closure via the energized electromagnetic clutch (e.g., clutch motor 19, armature disc 20, and clutch winding 23). Without the clutch (e.g., clutch motor 19, armature disc 20, and clutch winding 23), there would be the danger that the rotatory acceleration forces generated by the rapid raising and lowering of the spindle speed, as well as by change of load during operation of the spindle drive, would lead to a surmounting of the self-locking of the roller screw drive (e.g., roller screw shaft 12 and roller screw nut 13), and thus lead to an unwanted change in the clamping force.

The various force flows throughout the rotating spindle and clamping system do not act on the bearing system or other surrounding components.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A clamp for a chuck of a machine tool spindle, comprising:
a threaded shaft for adjusting clamping jaws of the chuck, the threaded shaft being axially adjustable in the clamp using a threaded nut connected to a rotor of a servomotor actuator, and
an electrically actuable, releasable clutch comprising a first clutch element that is connected in a rotationally secure and axially displaceable manner to the threaded shaft, and a second clutch element that cooperates with the first clutch element and is connected in a rotationally secure manner to the rotor.

2. The clamp according to claim 1, wherein the threaded shaft is a roller screw shaft, and the threaded nut is a roller screw nut.

3. The clamp according to claim 1, wherein the clutch is a friction clutch.

4. The clamp according to claim 1, wherein the clutch is configured such that, when in a currentless state, the first clutch element and the second clutch element are mutually rotatable.
